(19) United States
(12) Patent Application Publication
(10) Pub. No.: US 2011/0188492 A1
(43) Pub. Date: Aug. 4, 2011

(54) RESPONDING TO CALL CONTROL EVENTS USING SOCIAL NETWORK APPLICATIONS

(76) Inventor: DANIEL S. STOOPS, Powell, OH (US)

(21) Appl. No.: 12/697,337

(22) Filed: Feb. 1, 2010

(51) Int. Cl. H04L 12/66; H04M 1/64

(52) U.S. Cl. 370/352; 379/87

(57) ABSTRACT

Embodiments of methods of handling call control events are provided. An example method includes receiving, at an interpreter, information indicating a call control event associated with a call from a calling party to a called party. The calling party and/or the called party are subscribed to the social network. The example method also includes providing, from the interpreter, messaging information generated by an application server based on the call control event and information retrieved from the social network for the calling party and/or the called party.

### BACKGROUND OF THE INVENTION

1. Field of the Invention

This invention relates generally to communication systems, and, more particularly, to responding to call control events in communication systems.

2. Description of the Related Art

Service providers support voice calls in both wired and wireless communication systems. The voice calls can be point-to-point calls (e.g., when user places a telephone call to another user) or point-to-multipoint calls (e.g., when a group of users establishes a Push-To-Talk session). Call control within the communication system is typically provided according to predetermined and often long-standing rules or protocols. For example, the communication system may direct a calling party to a voicemail service when the called party is unavailable or occupied in another call. The calling party can then leave a message for the called party and the called party can retrieve the message at a later time. For another example, the communication system may provide a predetermined ring back tone that is played to the calling party while the calling party is waiting to be connected to the called party.

Conventional static call control and the associated content (e.g., ringing sounds, ring back music, voicemail greeting) may not be well suited to the demands and opportunities presented by the evolving communication and media environments of today. Many conventional call control features that were very useful several years ago are now rarely used. For example, conventional call control systems offer the calling party the option to leave a callback number when the called party is unavailable. Although this feature was once very useful, the ubiquitous adoption of caller ID technology allows communication devices to capture the number of the calling party, rendering the callback number feature redundant and confusing. For another example, conventional ring back tones are selected from a predetermined list of tones that are supported by the service provider.

### SUMMARY OF THE INVENTION

The limited number of ring back tones supported by a service provider for a called party constrains the amount of information that can be relayed by the ring back tone and typically makes it impossible to have the ring back tone reflect the current activity, emotion, or disposition of the called party. In addition, the conventional static representation of call control does not encourage frequent updates of the call control content by the subscriber thus missing the opportunity for advertising revenue that would be associated with dynamic call control content.

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for handling call control events. The method includes receiving, at an interpreter, information indicating a call control event associated with a call from a calling party to a called party. The calling party and/or the called party are subscribed to the social network. The method also includes providing, from the interpreter, content generated by an application server based on the call control event and information retrieved from the social network for the calling party and/or the called party.

In another embodiment, a method is provided for handling call control events. The method includes generating, at an application server, content in response to a call control event associated with a call from a calling party to a called party. The calling party and/or the called party are subscribed to a social network. The content is generated based on the call control event and information retrieved from the social network for the calling party and/or the called party. The application server provides the content to an interpreter.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a communication system;

FIG. 2 conceptually illustrates a first exemplary embodiment of a method of generating a response to a call control event using information provided by a social network; and

FIG. 3 conceptually illustrates a second exemplary embodiment of a method of generating a response to a call control event using information provided by a social network.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

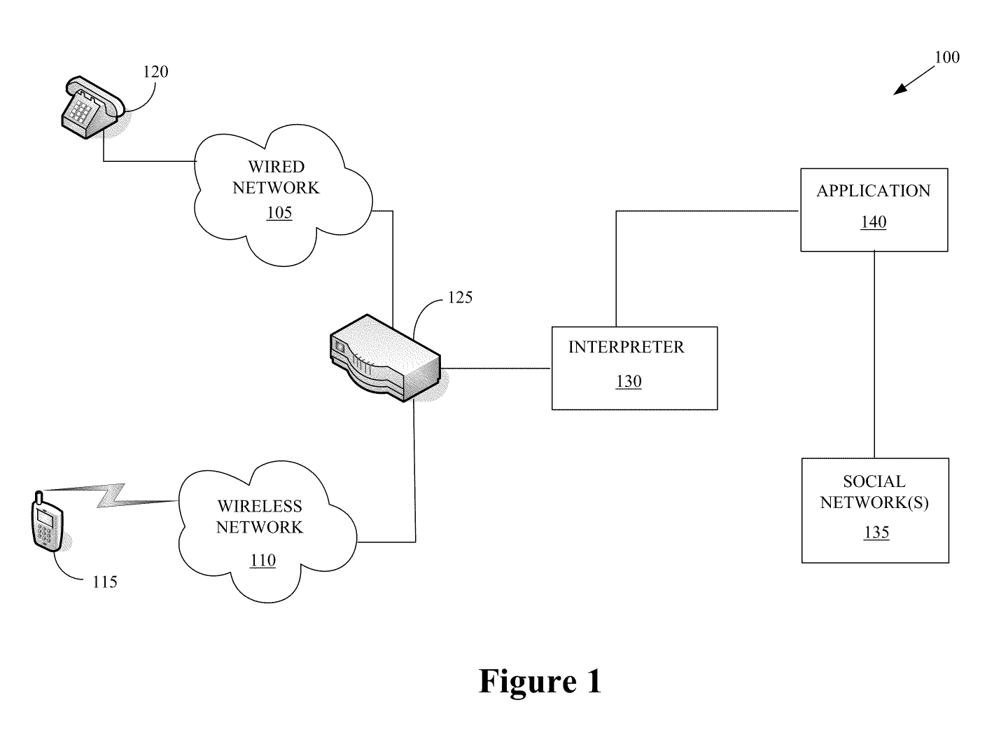

FIG. 1 conceptually illustrates one exemplary embodiment of a communication system 100. In the illustrated embodiment, the communication system 100 includes a wired network 105 and a wireless network 110. The wired network 105 is used to provide wired connectivity to one or more subscriber terminals 120 and the wireless network 110 is used to provide wireless connectivity to one or more mobile units 115. The networks 105, 110 operate according to well known standards and/or protocols. Accordingly, only those implementation features and/or operational aspects of the networks 105, 110 that differ from conventional practice and/or are relevant to the claimed subject matter will be discussed herein. Furthermore, persons of ordinary skill in the art having benefit of the present disclosure should appreciate that the wired network 105 and wireless network 110 are intended to be illustrative and not to limit the claimed subject matter. Alternative embodiments of the communication system 100 may include more or fewer wired and/or wireless networks 105, 110.

In the illustrated embodiment, the wired network 105 and the wireless network 110 are communicatively coupled to a network switch 125 that can be used to switch or route traffic between the networks 105, 110 and other entities in the communication system 100. For example, the network switch 125 may be used to carry signaling when the mobile unit 115 attempts to initiate a call with the subscriber terminal 120 (or vice versa). Exemplary network signaling protocols include Signaling System Number 7 (SS7), which is a set of telephony signaling protocols that may be used to set up (and tear down) calls such as public switched telephone network telephone calls, and Session Initiation Protocol (SIP) signaling. Call session initiation signals may be transmitted from the mobile unit 115 through the network switch 125 towards the subscriber terminal 120. If the call session is successfully established, then a communication pathway may be established from the mobile unit 115 to the subscriber terminal 120 via the wireless network 110, the network switch 125, and the wired network 105. The network switch 125 may also be used to carry call control event messaging, such as information indicating call events such as the unavailability of the subscriber terminal 120, a busy signal for the subscriber terminal 120, a no-answer signal from the subscriber terminal 120, and the like.

An interpreter 130 is coupled to the network switch 125. The interpreter 130 is configured to receive signaling (such as SS7 voice signaling) from the network switch 125 and “interpret” the signaling to facilitate interaction between the source of the signaling (e.g., the mobile unit 115 and/or the subscriber terminal 120) and other applications implemented in the system 100. The interpreter 130 can “answer” calls so that the network switch 125 (or other network entity) does not tear down the call or otherwise interrupt the call, as will be discussed herein. In one embodiment, the interpreter 130 is an Extensible Markup Language (XML) interpreter that implements VoiceXML. VoiceXML is the W3C′s standard XML format for specifying interactive voice dialogues between a human and a computer. It allows voice applications to be developed and deployed in an analogous way to HTML for visual applications. Just as HTML documents are interpreted by a visual web browser, VoiceXML documents are interpreted by a voice browser. One possible XML interpreter architecture includes banks of voice browsers attached to a Public Switched Telephone Network (PSTN) so that users can use a telephone (e.g., the mobile unit 115 and/or the subscriber terminal 120) to interact with voice applications 140.

The communication system 100 provides users access to one or more social networks 135. As used herein, the term “social network” will be understood to refer to a digital representation of a social structure formed of individuals (or organizations) that are tied, connected, and/or related by one or more specific types of interdependency such as “friendship.” The term “social network” also refers to the applications, algorithms, and information that are used create, delete, maintain, modify, and represent the social network on a server, a collection of servers, or other computing device. The social network 135 can be created and maintained using a social network service. In general, social networking services allow users/subscribers to create a profile that includes information such as birthdays, hometowns, status, messages, employers, educational history, interests, pictures, and the like. Exemplary social networking services include internal social networking (ISN) and external social networking (ESN) sites such as MySpace, Facebook, LinkedIn, Twitter, and Bebo. An ISN is a closed/private community that consists of a group of people within a company, association, society, education provider and organization or even an “invite only” group created by a user in an ESN. An ESN is open/public and available to all web users to communicate and are designed to attract advertisers.

In the illustrated embodiment, users of the mobile unit 115 and/or the subscriber terminal 120 may be members of one or more of the social networks 135. Users of the social networks 135 can upload media such as pictures, create personal profiles, and form relationships with other users. In most social networking services, both users confirm that they are friends before they are linked by a relationship. For example, if Alice lists Bob as a friend, then Bob would have to approve Alice's friend request before they are listed as friends. Information provided to the social network 135 by each user can also be distributed to some or all of the users that are linked by relationships. Information posted to the social network 135 by the subscribed user of the mobile unit 115 may be automatically distributed to the user's friends and/or friends of friends. Some social networks have additional features, such as the ability to create groups that share common interests or affiliations, upload or stream live videos, and hold discussions in forums. Professional social networks, such as Linked In, allow professionals to exchange information, opportunities, and ideas.

One or more applications 140 can be used to leverage information stored by the social network 135 to provide responses to call control events in the system 100. Subscribers can use the social network 135 (e.g., personal profiles and/or services provided by the social network) to control their call coverage experience. The applications 140 can also be used to program the call coverage call flow, which allows a development community to create an almost unlimited number of applications 140. However, the network switch 125 and other entities such as the networks 105, 110 operate according to protocols that are subject to different constraints than the protocols used by the application 140 and the social networks 135. For example, the network switch 125 may use SS7 to set up and tear down voice calls. The SS7 protocols are therefore configured to handle real-time voice signaling and to dispose of calls quickly when no party answers. These constraints can be incompatible with features of the HTML/HTTP protocols implemented by the application 140 and/or the social networks 135, which are not subject to stringent latency constraints at least in part because they are configured to handle media content (such as text, audio, and/or video) and are not necessarily constrained to operate in real-time.

The interpreter 130 serves as an interface, bridge, and/or translator between these two domains. The interpreter 130 is configured to answer calls received by the network switch 125 and then to act as a proxy or intermediary in the call. Using the interpreter 130 to answer calls can prevent the network switch 125 from disposing of calls, e.g. when the called party is not responsive. In one embodiment, the interpreter 130 may answer calls to busy and/or non-responsive devices so that the interpreter 130 acts as a proxy for the called party. Alternatively, the interpreter 130 may “entertain” or “inform” calls while the network switch 125 is attempting to establish a call to another device. For example, the interpreter 130 may receive SS7 signaling from the network switch 125 indicating that a device (such as the mobile unit 115) is initiating a call and the interpreter 130 may “answer” by exchanging the appropriate SS7 signaling with the network switch 125. The interpreter 130 can then communicate with the social networks 135 through the application 140 according to the appropriate protocols. For example, the interpreter 130 may communicate with the application 140 using Voice XML signaling.

The interpreter 130 can therefore allow call coverage (e.g., for calls passing through the network switch 125) to be implemented using information stored in social network 135. In one exemplary embodiment, the interpreter 130 communicates with a call logic application 140 to select options for a calling party when a call event indicates that the called party is unavailable or does not answer. In another exemplary embodiment, the interpreter 130 functions as a media playing element for ring back content to allow the interpreter 130 to create media content to be played during a ring back call event. The application 140 is configured to determine the ring back media content using information retrieved from the social network 135. The applications 140 can be written by social network application developers. This enables the social network development team to determine the call coverage logic and put the social network subscriber in control through provisioning the application 140 so as to produce the specific call logic that responds to different specified call events. The act of provisioning the call logic in a social network can expose the subscriber to advertising which is a revenue source that can be shared with the service provider who owns the communication system 100.

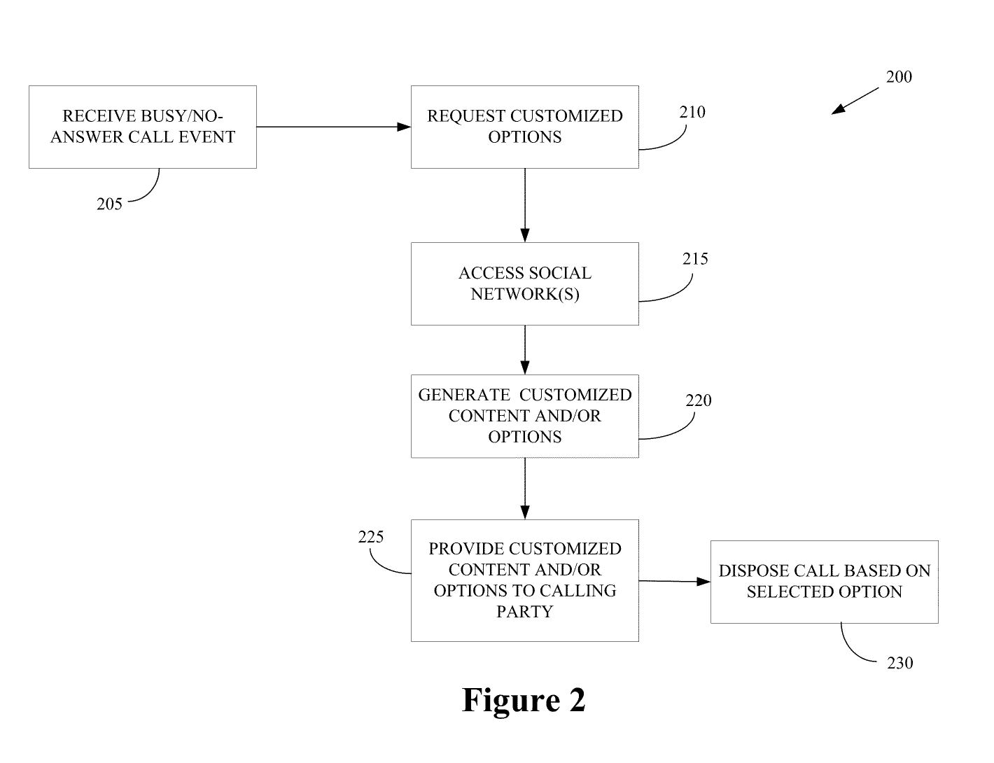

FIG. 2 conceptually illustrates a first exemplary embodiment of a method 200 of generating a response to a call control event using information provided by a social network. In the illustrated embodiment, a calling party is attempting to establish a call session with a called party. However, the called party is either busy or does not answer the call within a predetermined amount of time. A busy/no-answer call control event is therefore generated in the system and received (at 205) at a network switch in the call path. For example, the network switch may receive (at 205) SS7 signaling indicating the busy/no-answer call control event. In response to the call control event, the network switch requests (at 210) a telephony connection to inform the calling party of the busy/no answer event. The request is forwarded to an interpreter (such as a VXML or CCML interpreter that understands SS7 signaling provided by the network switch), which interprets the event and uses this to generate a request that is transmitted to an application configured to provide customized options as voice content in response to the busy/no-answer call control event.

The application accesses (at 215) one or more social networks associated with the calling party and/or the called party, depending on which parties are subscribed to the social networks. In one embodiment, the application can select a different social network depending upon the characteristics of the calling party and/or the called party. For example, the application can access (at 215) Facebook when the calling party and the called party are friends, LinkedIn when the calling party and the called party are colleagues, and Twitter when there is no relationship (or an unknown relationship) between the calling party and the called party. The application can use information associated with the calling party and/or the called party stored on the social networks to generate (at 220) customized options and/or content. The number of possible options and/or content that can be provided to the calling party is almost unlimited, as is the kind of social network information that can be used to configure these options. In one embodiment, the application may select a set of possible response options from a group that includes options such as transmitting call coverage responses including a branding tone, a personalized message from the called party, information posted to the social network by the calling party and/or the called party (e.g., information on the “wall” of the social network), an option to leave a message on the called party's social network or in a separate voice mailbox, an option to invoke another application implemented by the social network, and the like.

One exemplary call coverage response to a busy/no-answer call control event can be represented in pseudo-code as:

<Branding Tone> “AT&T Facebook”
<Called Party Voice Message> “I'm busy but check me

out.”

<Miss AnyPath> “Press 1 to hear what is on my wall.”
<Miss AnyPath> “Press 2 to leave a message on my wall.”
<Miss AnyPath> “Press 3 to poke me.”
<Miss AnyPath> “Press 4 to hear what is on my mind.”
<Miss AnyPath> “Press 5 or stay on the line to be

directed to my voice mailbox.”

<Beep>

However, persons of ordinary skill in the art having benefit of the present disclosure should appreciate that this call coverage pseudo-code is intended to be illustrative and not to limit the claimed subject matter.

Alternative call coverage response options may include other information and/or options derived from the social networking data. These alternative options may include such things as dictating a short message (SMS), allowing the calling party to break into an existing call and “whisper” a short message, attempting to connect to a different called party, sending call connection requests to different phones associated with the called party, hearing information (such as tweets) from other social networks, and the like. The call coverage can also be customized based upon the calling party's information. For example, the personal greeting from the called party can be customized based on the identity of the calling party, the called party can select information from the social network to be played as the greeting, and the like. The call coverage may also be customized based upon the relation between the calling party and the called party that is established in the social network. For example, one set of options may be provided when the calling party and the called party are friends and a different set of options may be provided when the calling party and the called party are connected by a friend-of-a-friend relationship.

The generated set of customized options can then be provided (at 225) to the calling party. For example, the application can return content including VXML and/or CCML code to the interpreter, which can then use the returned content to create a voice/audio response that is played to the calling party. The voice/audio response can be transmitted to the network switch using SS7 signaling generated by the interpreter using the VXML and/or CCML code. In embodiments that allow the calling party to select one of the options, the call can then be disposed (at 230) based upon the option selected by the calling party. For example, if the calling party elects to hear a portion of the called party's wall, then the interpreter may send a request for this information to the application, which can generate the appropriate response based on the information currently available on the called party's wall. This information can be returned to the interpreter, which generates a voice/audio response that can be played to the calling party. The voice/audio response can be transmitted to the network switch using SS7 signaling generated by the interpreter using VXML and/or CCML code generated by the application. However, persons of ordinary skill in the art having benefit of the present disclosure should appreciate that the media content generated by the interpreter is not limited to voice/audio content. In alternative embodiments, text, pictures, video, and other types of media content can be provided, e.g., in more advanced telephony networks such as IP Multimedia Subsystem (IMS). In these manners, call control content that more accurately reflects a subscriber's current activity, emotion or disposition can be provided.

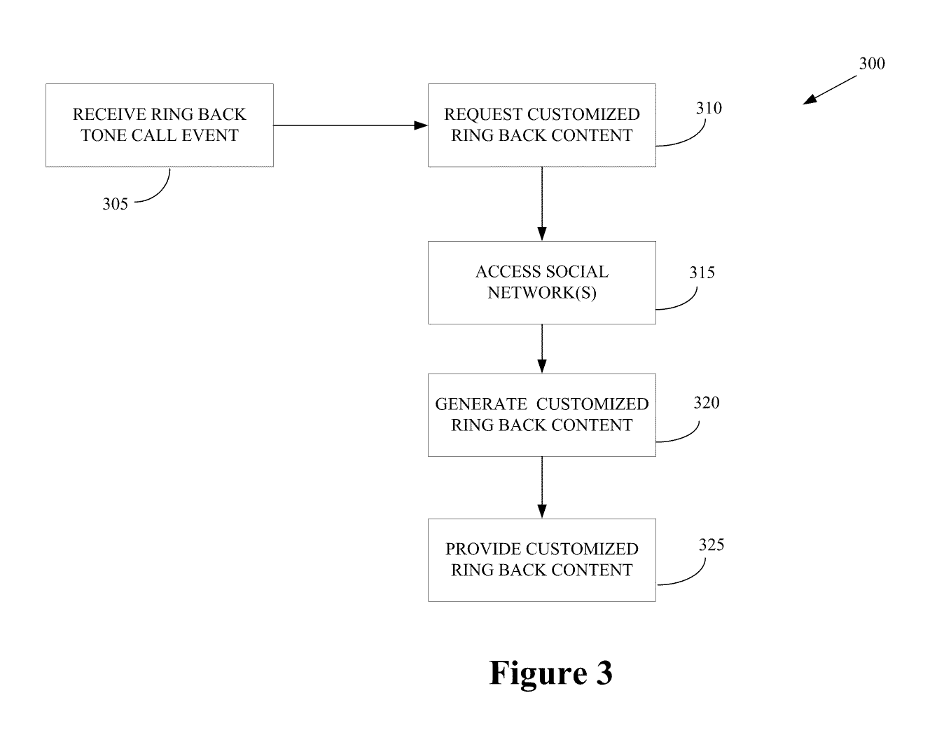

FIG. 3 conceptually illustrates a second exemplary embodiment of a method 300 of generating a response to a call control event using information provided by a social network. In the illustrated embodiment, a calling party is attempting to establish a call session with a called party. While the calling party is waiting for the called party to respond, the system is configured to provide ring back content to the calling party. A ring back tone call control event is therefore generated in the system and received (at 305) at a network switch in the call path. The network switch may create/transmit the ring back tone call control event using SS7 signaling. In response to the call control event, the network switch requests (at 310) customized ring back content that can be provided to the calling party while waiting for the called party to respond. The request is forwarded to an interpreter (such as a VXML or CCML interpreter that understands SS7 signaling), which interprets the voice signaling and uses this to generate a request that is transmitted to an application configured to provide customized ring back content in response to the ring back tone call control event. For example the interpreter may generate VXML or CCML code based on the SS7 signaling used to transmit the voice content. The VXML or CCML code can then be transmitted to the application.

The application accesses (at 315) one or more social networks associated with the calling party and/or the called party, depending on which parties are subscribed to the social networks. In one embodiment, the application can select a different social network depending upon the characteristics of the calling party and/or the called party. For example, the application can access (at 315) Facebook when the calling party and the called party are friends, LinkedIn when the calling party and the called party are colleagues, and Twitter when there is no relationship (or an unknown relationship) between the calling party and the called party. The application can then use information associated with the calling party and/or the called party stored on the social networks to generate (at 320) customized ring back content. The ring back content may be generated (at 320) using information retrieved from the calling party's social network. For example, if the calling party selected a “poem-of-the-day” on their social network, the application may access the poem and use it to generate (at 320) the ring back content that is played to the calling party. The ring back content may also be generated (at 320) using information retrieved from the called party's social network. For example, the application may access a current status, tweet, or “on your mind” entry from the social network and use this to generate (at 320) the customized ring back content. The ring back content may also be generated (at 320) based upon relationships between the calling party and the called party on the social network. For example, customized ring back content may be played when the calling party and the called party are friends in the social network and a default system-provided ring back tone may be played when the calling party and the called party are not related in the social network.

One exemplary call coverage response to a ring back tone call control event can be represented in pseudo-code as:

<Branding Tone> “AT&T Facebook”
<Text-to-speech> “Woke up to a dozen sweet kisses from

Caroline!! It's going to be a great day!”

<Miss Facebook> “Press 1 to hear what is on my wall.”
<Miss Facebook> “Press 2 to hear your favorite song.”
<Miss Facebook> “Press 3 to hear my favorite song.”
<Ringing Sound>
<Call Complete>

However, persons of ordinary skill in the art having benefit of the present disclosure should appreciate that this call coverage is intended to be illustrative and not to limit the claimed subject matter.

The generated ring back content can then be provided (at 325) to the calling party.

For example, the application can return a message including VXML and/or CCML code to the interpreter, which can then use this information to create a voice/audio response that is played to the calling party. The voice/audio response may be provided to the network switch using SS7 signaling. For example, if the called party provisions the application to play a portion of the called party's wall as the ring back tone, then the interpreter may send a request for this information to the application, which can generate the appropriate response based on the information currently available on the called party's wall. This information can be returned to the interpreter, which generates a voice/audio response that can be played to the calling party. However, persons of ordinary skill in the art having benefit of the present disclosure should appreciate that the media content generated by the interpreter is not limited to voice/audio content. In alternative embodiments, text, pictures, video, and other types of media content can be provided.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
receiving, at an interpreter, information indicating a call control event associated with a call from a calling party to a called party, wherein at least one of the calling party or the called party is subscribed to a social network; and
providing, from the interpreter, content generated by an application server based on the call control event and information retrieved from the social network for at least one of the calling party or the called party.

2. The method of claim 1, wherein receiving the information indicating the call control event comprises receiving at least one of SS7 signaling or Session Initiation Protocol (SIP) signaling indicating calling party information at a voice XML interpreter, and wherein providing the content comprises providing voice information and SS7 signaling generated by the voice XML interpreter using the information generated by the application server as VoiceXML code.

3. The method of claim 1, wherein receiving information indicating the call control event comprises receiving information indicating no answer from the called party or that the called party is busy.

4. The method of claim 3, wherein providing the content generated by the application server comprises providing at least one response option to the calling party.

5. The method of claim 4, wherein providing said at least one response option comprises providing at least one response option selected from a set of response options based on the information retrieved from the social network.

6. The method of claim 4, wherein providing said at least one response option comprises providing at least one response option that has been modified based on the information received from the social network.

7. The method of claim 1, wherein receiving information indicating the call control event comprises receiving a request for a ring back tone to be played to the calling party.

8. The method of claim 7, wherein providing the content generated by the application server comprises providing ring back content selected from a set of ring back tones based on the information retrieved from the social network.

9. The method of claim 7, wherein providing the content generated by the application server comprises providing ring back content that has been modified based on the information retrieved from the social network.

10. A method, comprising:
generating, at an application server, content in response to a call control event associated with a call from a calling party to a called party, wherein at least one of the calling party or the called party is subscribed to a social network, the content being generated based on the call control event and information retrieved from the social network for said at least one of the calling party or the called party; and
providing, from the application server to an interpreter, the content.

11. The method of claim 10, comprising receiving a request for the content from the interpreter in response to the interpreter receiving information indicating the call control event.

12. The method of claim 11, wherein receiving the request for the content comprises receiving a request generated using SS7 or SIP signaling indicating calling party voice information received at a voice XML interpreter, and wherein providing the content comprises providing the content to the voice XML interpreter as Voice XML code.

13. The method of claim 10, wherein generating the content in response to the call control event comprises generating the content in response to information indicating no answer from the called party or that the called party is busy.

14. The method of claim 13, wherein generating the content comprises generating at least one response option for the calling party.

15. The method of claim 14, wherein generating said at least one response option comprises selecting at least one response option from a set of response options based on the information retrieved from the social network.

16. The method of claim 14, wherein generating said at least one response option comprises modifying at least one response option based on the information received from the social network.

17. The method of claim 10, wherein generating the content in response to the call control event comprises generating ring back content to be played to the calling party.

18. The method of claim 17, wherein generating the ring back content comprises selecting the ring back content from a set of ring back tones based on the information retrieved from the social network.

19. The method of claim 17, wherein generating the ring back content comprises modifying a ring back tone based on the information retrieved from the social network.

20. An apparatus comprising an interpreter configured to be communicatively coupled to a network switch and at least one application server, the interpreter being configured to:
receive, from the network switch, information indicating a call control event associated with a call from a calling party to a called party, wherein at least one of the calling party or the called party is subscribed to at least one social network; and
provide, to the network switch, content generated by said at least one application server based on the call control event and information retrieved from said at least one social network for at least one of the calling party or the called party.

21. The apparatus of claim 20, wherein the interpreter is configured to answer calls from the calling party received by the network switch and to act as a proxy or intermediary in the call.

22. The apparatus of claim 20, wherein the interpreter is configured to communicate with said at least one application server using voice XML signaling.

23. The apparatus of claim 20, wherein the interpreter functions as a media playing element for ring back content to be played during a ring back call event.
